(19) United States
(12) Patent Application Publication
(10) Pub. No.: US 2026/0018726 A1
(43) Pub. Date: Jan. 15, 2026

(54) BATTERY UNIT OF VEHICLE

(71) Applicant: HONDA MOTOR CO., LTD., Tokyo (JP)

(72) Inventors: Yu Iemura, Wako-shi (JP); Shutaro Sao, Wako-shi (JP); Ken Yasui, Wako-shi (JP)

(21) Appl. No.: 19/259,060

(22) Filed: Jul. 3, 2025

(30) Foreign Application Priority Data
Jul. 10, 2024 (JP) 2024-111099

(51) Int. Cl. H01M 50/242; H01M 50/249; H01M 50/271

(52) U.S. Cl. CPC H01M 50/242; H01M 50/249; H01M 50/271

(57) ABSTRACT

A battery unit includes battery module and battery housing case. The battery housing case includes a pair of frame members and a plurality of cross members. Both ends of the cross member in extending direction is connected to the pair of frame members. The module case includes cover wall connected to each of two adjacent cross members. At least one of the cross members includes multi-rib structure and single rib. The multi-rib structure branches into a plurality of ribs from one end side to the other end side and then rejoining the plurality of ribs to one rib. The end of single rib portion in the extending direction are connected to the multiple rib structure portion. The end of the cover wall is connected to a vicinity of a portion of the multi-rib structure portion where a number of ribs changes from a plurality of ribs to one rib.

### CROSS-REFERENCE TO RELATED APPLICATION

This application claims priority on Japanese Patent Application No. 2024-111099, filed on Jul. 10, 2024, the contents of which are incorporated herein by reference.

### BACKGROUND OF THE INVENTION

### Field of the Invention

The present invention relates to a battery unit for a vehicle, in which a battery module is housed in a battery housing case.

### Description of Related Art

A battery unit for a vehicle is known in which a plurality of battery cells are accommodated in a battery accommodation case and the battery accommodation case is attached to a frame member of the vehicle (see, for example, Japanese Unexamined Patent Application, First Publication No. 2019-106283).

A battery unit for a vehicle disclosed in Japanese Unexamined Patent Application, First Publication No. 2019-106283 includes a battery module in which a plurality of stacked battery cells are stored, and a battery housing case for housing the battery module. The battery housing case is provided with a bottom wall member for mounting the battery module on the upper surface of the bottom wall member, and a plurality of frame members that is connected to the upper surface of the bottom wall member and that surrounds the outside of the battery module.

In the battery unit of a vehicle described in Japanese Unexamined Patent Application, First Publication No. 2019-106283, since the plurality of frame members are connected to the bottom wall member so as to surround the outside of the battery module, when an impact load is inputted from the outside, the battery module (battery cell) on the bottom wall member can be protected by the frame member.

### SUMMARY OF THE INVENTION

The battery unit of a vehicle described in Japanese Unexamined Patent Application, First Publication No. 2019-106283 is structured so that when an impact load is inputted from the outside, the load is received by a frame member of a battery housing case. Therefore, in order to reliably protect the battery cells accommodated in the battery accommodating case from the input of the impact load, it is necessary to increase the number of frame members or to enlarge the frame members. However, this causes the battery housing case to be large and heavy, and therefore, improvement is desired.

An aspect of the present invention is to provide a battery unit for a vehicle, which can efficiently receive an input impact load by a portion other than a battery cell while avoiding an increase in size and weight of a battery housing case. The aspect of the present invention contributes to the improvement of the energy efficiency of the vehicle by reducing the size and weight of the battery housing case.

The battery unit of the vehicle according to the present invention employs the following configuration.

Specifically, a battery unit of a vehicle is provided with a battery module (for example, the battery module 7 of the embodiment) in which battery cells (for example, the battery cells 6 of the embodiment) are stored in a module case (for example, the module case 40 of the embodiment), and a battery housing case (for example, the battery housing case 10 of the embodiment) which is attached to a vehicle frame member (for example, the side sill 3 of the embodiment) and houses the battery modules therein, wherein the battery housing case is provided with a pair of frame members (for example, the frame members 11 of the embodiment) extending along a first direction substantially orthogonal to the vertical direction, and a plurality of cross members (for example, the first cross members 12f, the second cross members 12s, and the third cross members 12t of the embodiment) extending along the vertical direction and a second direction substantially orthogonal to the first direction, and both ends of the cross members in the extending direction being connected to the pair of frame members, the module case is provided with a cover wall (for example, the cover wall 42 of the embodiment) which covers the upper side of the battery cells, and both ends of the cover wall in the first direction being connected to each of two adjacent cross members, at least one of the adjacent cross members is provided with a multi-rib structure section (for example, the multi-rib structure section 51 of the embodiment) in which a rib (for example, the rib 50 of the embodiment) branch from one rib to a plurality of ribs from one side toward the other end side in the second direction, and then the rib rejoins into one rib again, and a single rib section (for example, the single rib section 52 of the embodiment) extending along the second direction and having the end portion of the single rib portion in the extending direction connected to the multi-rib structure section, and the both ends of the cover wall are connected to the vicinity of a portion of the multi-rib structure section where the number of ribs changes from a plurality of ribs to one rib.

In the battery unit of the present embodiment, the edges of the cover wall of the battery module on both sides in the first direction are connected to two adjacent cross members. Therefore, when an impact load is input to one frame member from one side in the second direction, the impact load transmitted to the adjacent one cross member is efficiently transmitted to the other cross member through the cover wall. As a result, the input impact load is efficiently distributed and supported by the plurality of cross members through the cover wall.

In particular, in the present embodiment, at least one of the adjacent cross members has the multi-rib structure portion and the single rib portion connected to each other in the second direction, and the edge of the cover wall is connected to the vicinity of the portion of the multi-rib structure portion where the number of ribs changes from a plurality of ribs to one rib. Therefore, the impact load transmitted to the multi-rib structure of the cross member is transmitted to the cover wall through the portion which is relatively liable to displace in the outward opening direction with respect to the input load. As a result, the impact load input to one cross member is efficiently transmitted to the other cross member through the cover wall. Therefore, in the case where this configuration is adopted, it is possible to efficiently receive the input impact load by using the cover wall without increasing the number of cross members or increasing the size of the cross members.

The cross member having the multi-rib structure and the single rib may be provided with a widened portion (for example, the widened portion 45 of the embodiment) having a width gradually increasing in the first direction toward a fixing portion (for example, the fixing portion 44 of the embodiment) with the frame member.

In this case, the impact load input to one of the frame members from one side in the second direction is transmitted from the fixing portion of the cross member with the frame member to the multiple rib structure portion and the single rib portion through the widened portion. Since the width of the widened portion in the first direction gradually decreases from the fixed portion with the frame member toward the multiple rib structure portion and the single rib portion, a load input from the frame member to the cross member is easily transmitted to the multiple rib structure portion and the single rib portion. Therefore, the impact load input to one cross member is easily transmitted to the other cross member through the cover wall.

Further, an impact load input from one side of one cross member is transmitted to the other frame member through the widened portion on the other side of the cross member. At this time, since the width of the widened portion on the other side gradually increases in the first direction toward the fixed portion with the other frame member, the impact load is stably received by the wide range in the first direction of the other frame member.

Therefore, when this configuration is adopted, it is possible to receive the input impact load more efficiently in the portion other than the battery cell.

A connection portion (for example, the fastening boss portion 54 of the embodiment) to the cover wall may be provided in the vicinity of a portion of the multi-rib structure portion of the cross member where the number of the ribs changes from a plurality of ribs to one rib, via a plurality of reinforcing ribs (for example, the reinforcing ribs 53 of the embodiment) extending along the first direction.

In this case, a plurality of reinforcing ribs extend from the multi-rib structure of the cross member in a direction perpendicular to the extending direction of the cross member, and a connecting portion with respect to the cover wall is continuously provided at the plurality of reinforcing ribs. Therefore, the impact load input to the multi-rib structure of the cross member can be efficiently transmitted to the cover wall through the plurality of reinforcing ribs.

A separate space (e.g., the separate space S in the embodiment) spaced apart in the second direction may be provided between the frame member and the battery module.

In this case, when an impact load is input to one of the frame members from one side in the second direction, the impact load is received by the cross member and the cover wall of the battery module. At this time, even if a part of one frame member is displaced in the second direction, a separate space is secured between the frame member and the battery module, and therefore, it is difficult for the load to be directly transmitted from the frame member to the battery module. Therefore, when this configuration is adopted, it is possible to protect the battery cell more advantageously at the time of inputting the impact load.

The two adjacent cross members may be provided at positions where connecting portions (for example, the fastening boss portions 54, 65 of the embodiment) to the cover wall are shifted from each other in the second direction.

In this case, when an impact load is input to one of the frame members from one side in the second direction, the load is received by the two adjacent cross members and also by the cover wall. At this time, the connecting portions, which are the portions where the loads are transmitted from the two cross members to the cover wall, are disposed at positions shifted from each other in the second direction. Therefore, the cover wall is less likely to be bent and deformed when an impact load is input, and the impact load can be efficiently received by the cover wall.

According to the battery unit of the vehicle according to the present invention, the input impact load can be efficiently received by the portion other than the battery cell while avoiding the increase in size and weight of the battery housing case. Therefore, when the battery unit according to the present invention is employed, the overall battery housing case can be made smaller and lighter, thereby contributing to the improvement of the energy efficiency of the vehicle.

### BRIEF DESCRIPTION OF THE DRAWINGS

FIG. 1 is a cross-sectional view showing a structure of a lower portion of a vehicle body of a vehicle according to an embodiment;

FIG. 2 is a plan view of the battery unit of the embodiment.

FIG. 3 is a plan view of the battery unit, showing a portion of FIG. 2 in an enlarged manner.

FIG. 4 is an enlarged view of part IV of FIG. 3.

FIG. 5 is a plan view of a portion of the third cross member according to the embodiment, corresponding to the V portion in FIG. 3.

### DETAILED DESCRIPTION OF THE INVENTION

An embodiment of the present invention will be described below with reference to the drawings. In the drawing, an arrow FR pointing forward of the vehicle 1, an arrow UP pointing upward of the vehicle 1, and an arrow LH pointing leftward of the vehicle 1 are shown at appropriate positions.

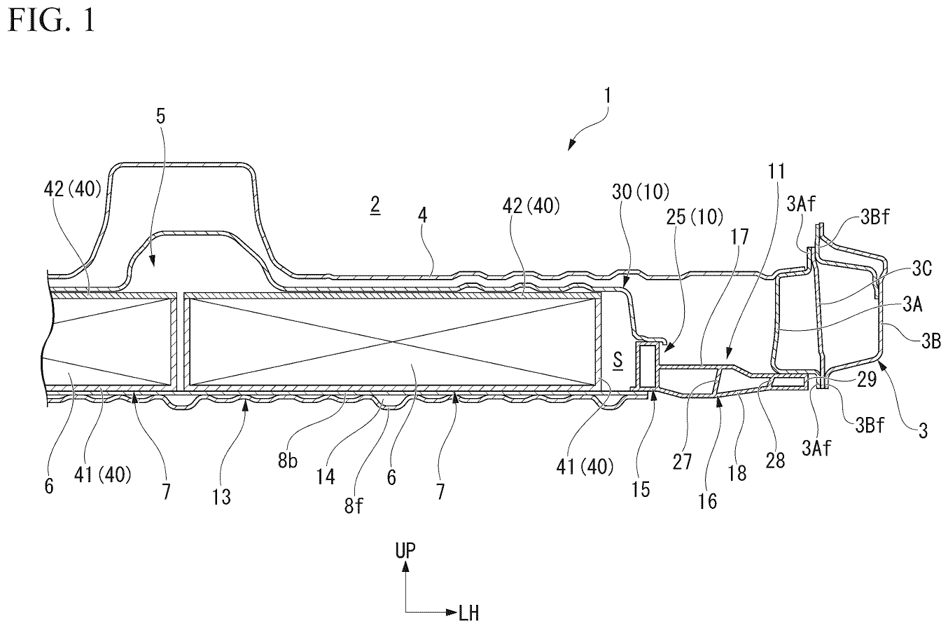

FIG. 1 is a view showing a vehicle body lower structure of a vehicle 1. FIG. 1 is a sectional view of a lower portion of the vehicle 1 taken in a direction perpendicular to the vehicle body front-rear direction.

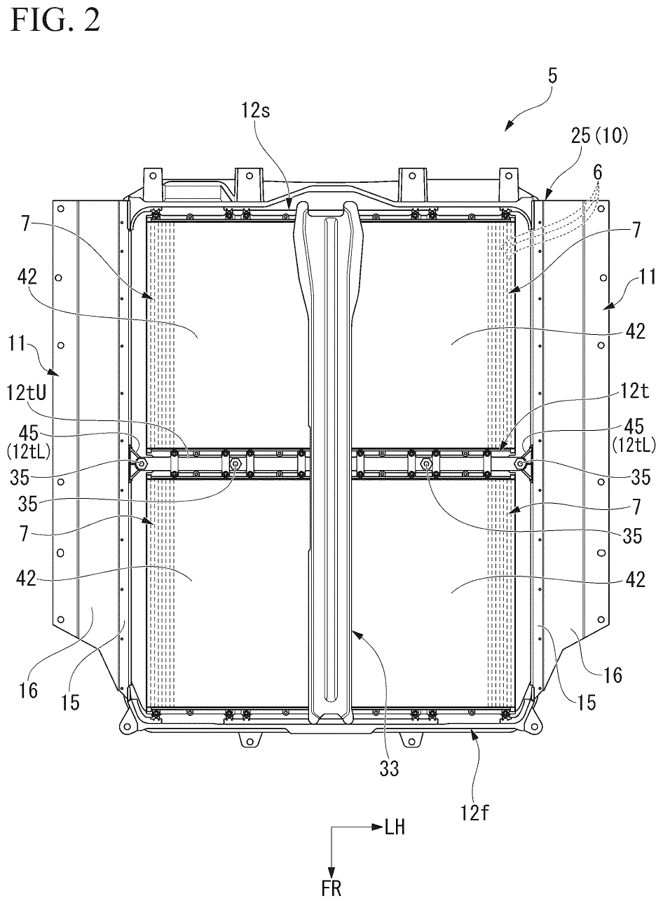

A pair of side sills 3, which are frame members of the vehicle body and extend substantially along the vehicle body front-rear direction, are disposed at lower positions of both sides of the vehicle compartment 2 in the vehicle width direction. In FIG. 1, only one side sill 3 is shown. Floor panels 4 are installed on the left and right side sills 3. A battery unit 5 is disposed below the floor panel 4 so as to extend substantially along the lower surface of the floor panel 4. The battery unit 5 includes a battery module 7 in which a plurality of battery cells 6 (see FIG. 2) are stacked and a battery housing case 10 which is attached to the left and right side sills 3 of the vehicle and in which the battery modules 7 is housed.

The battery housing case 10 includes a case body 25 on which a plurality of battery modules 7 (battery cells 6) and control devices (not shown) are mounted on the upper surface side, and a cover member 30 that covers the upper portion of the case body 25.

The case body 25 is formed in a substantially rectangular shape in a plan view. The left and right side edges of the case body 25 are fixed at the lower surfaces of the corresponding left and right side sills 3 by fastening members (not shown).

The side sill 3 is constructed by sandwiching a stiffener 3C between a side sill inner 3A and a side sill outer 3B having a hat-shaped cross section. The side sill inner 3A and the side sill outer 3B have upper and lower joint flanges 3Af and 3Bf. Upper and lower joint flanges 3Af and 3Bf of the side sill inner 3A and the side sill outer 3B are arranged to face each other. The joint flanges 3Af and 3Bf facing each other are connected by welding or the like in a state where the stiffener 3C is sandwiched between them.

The side sill inner 3A has an inner bulge 3Ac having a U-shaped cross section that bulges inward in the vehicle width direction from the base of the upper and lower joint flanges 3Af, 3Bf. The left and right side edge portions of the case body 25 are connected to the lower surface of the inner bulge 3Ac of the side sill inner 3A.

FIG. 2 is a plan view of the battery unit 5. In FIG. 2, the cover member 30 is omitted.

The case body 25 of the battery housing case 10 is provided with a pair of frame members 11 extending substantially along the vehicle body front-rear direction. The pair of frame members 11 are arranged so as to be spaced apart from each other in the vehicle width direction. The pair of frame members 11 are connected by a first cross member 12f, a second cross member 12s, and a third cross member 12t that are extending in the vehicle width direction. The both ends of the first cross member 12f in the extending direction are connected to the vicinity of the front end of the left and right frame members 11, and the both ends of the second cross member 12s in the extending direction are connected to the vicinity of the rear end of the left and right frame members 11. The both ends of the third cross member 12t in the extending direction are connected to a substantially central position of the left and right frame members 11 in the front-rear direction.

In the present embodiment, the vehicle body front-rear direction is a first direction substantially perpendicular to the vertical direction, and the vehicle width direction is a second direction substantially perpendicular to the vertical direction and the first direction. The pair of frame members 11 extend in a first direction (vehicle body front-rear direction) and are disposed so as to be spaced apart from each other in a second direction (vehicle width direction). The first, second and third cross members 12f, 12s and 12t extend in the second direction (vehicle width direction) and are connected at their opposite ends in the extending direction to the pair of frame members 11.

The case body 25 further includes a bottom wall member 13 that covers a lower space between the pair of frame members 11. The bottom wall member 13 is formed in a rectangular shape in a plan view, and the lower ends of the pair of frame members 11 and the first, second, and third cross members 12f, 12s, and 12t are connected to the upper surface side of the bottom wall member 13. A plurality (four) of battery modules 7 are mounted on the upper surface side of the bottom wall member 13. Two battery modules 7 are mounted side by side in the vehicle width direction on the front upper surface of the bottom wall member 13 with the third cross member 12t interposed therebetween, and the remaining two battery modules 7 are similarly mounted side by side in the vehicle width direction on the rear upper surface of the bottom wall member 13 with the third cross member 12t interposed therebetween. The battery module 7 (a plurality of battery cells 6) accommodated in the case body 25 is surrounded on the outer periphery by a pair of frame members 11 and first, second and third cross members 12f, 12s and 12t.

The number of battery modules 7 accommodated in the battery accommodating case 10 is not limited to four, and any number of battery modules 7 may be selected according to the size of the battery accommodating case 10, the layout of the mounted components, and the like.

As shown in FIG. 2, a device mounting frame 33 is provided above the first cross member 12f and the second cross member 12s of the battery housing case 10. The device mounting frame 33 is installed in the central portion of the first cross member 12f and the second cross member 12s in the vehicle width direction so as to stride over the front and rear portions of the central region of the four battery modules 7 in the vehicle width direction. A control device (not shown) and its wiring are mounted on the upper portion of the device mounting frame 33.

The bottom wall member 13 includes a base wall 8b facing the housing portion of the battery module 7 and a flow path forming wall 8f joined to the lower surface side of the base wall 8b. The flow path forming wall 8f forms a cooling liquid passage 14 for flowing the cooling liquid in the inside between the flow path forming wall 8f and the lower surface of the base wall 8b. The plurality of battery modules 7 accommodated in the battery accommodation case 10 are cooled by the cooling liquid flowing through the cooling liquid passage 14. The bottom wall member 13 has a multi-wall structure having a hollow portion therein, which is formed by the base wall 8b and the flow path forming wall 8f below the base wall 8b. The bottom wall member 13 is maintained with high rigidity by the multi-wall structure.

Each battery module 7 has a plurality of battery cells 6 stored in a rectangular module case 40 having a narrow vertical width. The plurality of battery cells 6 are stacked in the module case 40 along the vehicle width direction. The battery cells 6 are stored together in the battery housing case 10 as battery modules 7 in a predetermined number. The module case 40 includes a case body 41 which is opened at the upper side and which stores a plurality of battery cells 6 therein, and a cover wall 42 which is attached to the upper surface of the case body 41 and which closes the opening of the case body 41. The cover wall 42 covers the upper portion of the plurality of battery cells 6 in the case body 41 in a state where the cover wall 42 is attached to the case body 41. The case body 41 and the cover wall 42 forming the module case 40 are formed of a metal plate or the like having a high rigidity.

Each of the battery modules 7 accommodated in the battery accommodating case 10 have a separated space S between the frame members 11 so as not to be in contact with the frame members 11 adjacent to the battery modules 7 in the vehicle width direction.

As shown in FIG. 1, the frame member 11 has a hollow base frame portion 15, to which the extending ends of the first, second and third cross members 12f, 12s and 12t are connected on the inner surface in the vehicle width direction, and a hollow mounting frame portion 16 extending from the outer end of the base frame portion 15 in the vehicle width direction toward the outer side in the vehicle width direction.

The base frame portion 15 is formed in a closed section having a vertically elongated rectangular shape in a section perpendicular to the vehicle body front-rear direction. The rectangular closed section of the base frame portion 15 extends substantially along the vehicle body front-rear direction.

The mounting frame portion 16 has an upper wall portion 17, the inner end of which in the vehicle width direction is connected to the approximate center position of the base frame portion 15 in the height direction, and a lower wall portion 18, the inner end of which in the vehicle width direction is connected to the lower end of the base frame portion 15. The lower wall portion 18 is disposed at a position substantially equal to the height of the bottom wall member 13. The outer ends of the upper wall portion 17 and the lower wall portion 18 in the vehicle width direction are closed by end walls 29 which rise substantially along the vertical direction.

The mounting frame portion 16 has a substantially rectangular closed cross-section formed by the side wall of the base frame portion 15 on the outer side in the vehicle width direction, the upper wall portion 17, the lower wall portion 18, and the end wall 29. The closed section extends in the vehicle body front-rear direction. The closed section of the mounting frame portion 16 is reinforced by a reinforcing rib 27, 28.

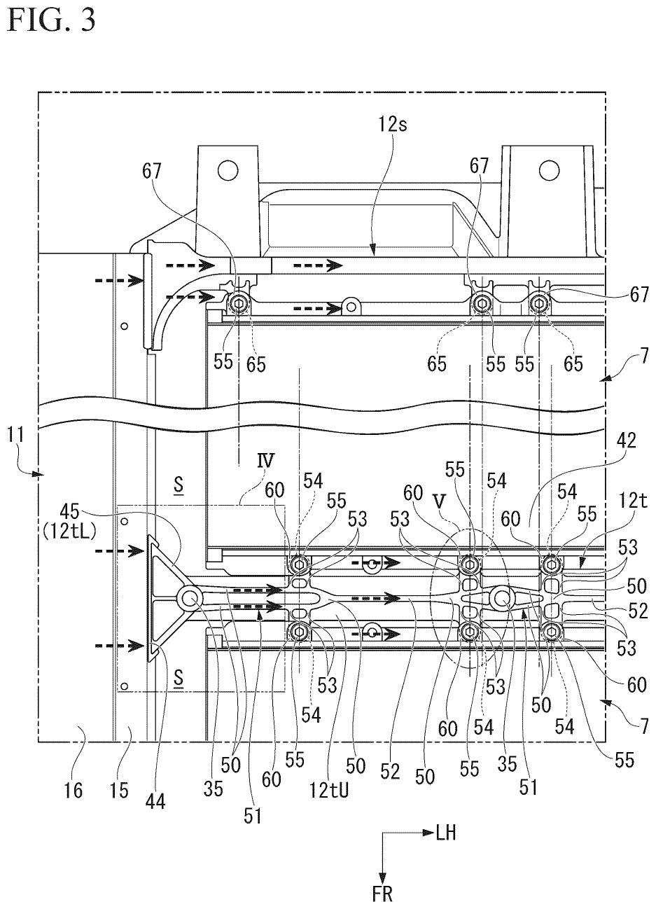

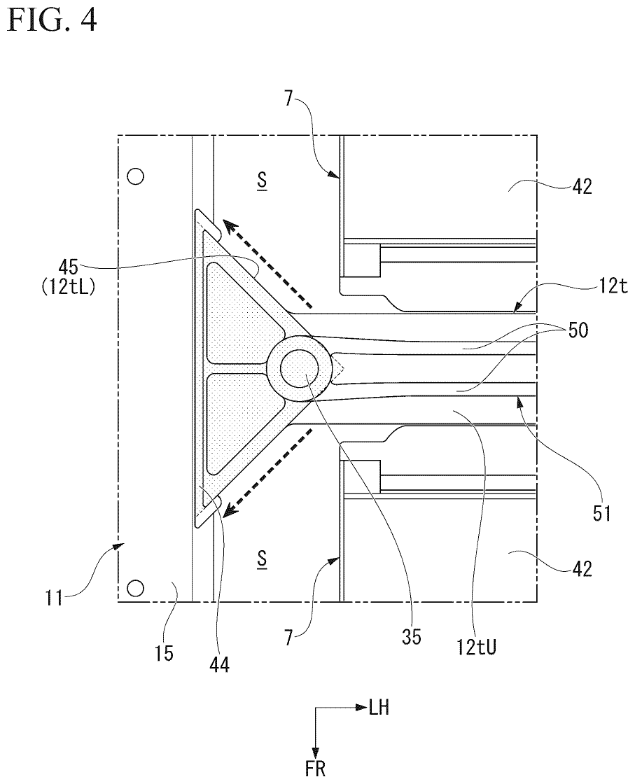

FIG. 3 is a plan view of the battery unit 5 in which a part of FIG. 2 is enlarged. FIG. 4 is an enlarged view of the portion IV of FIG. 3.

A third cross member 12t, which is arranged at the center position of a battery housing case 10 in the front-rear direction, is provided with a lower member 12tL, the ends of which on both sides in the extending direction are welded and fixed to base frame sections 15 of left and right frame members 11, and an upper member 12tU, which is placed on the upper surface of the lower member 12tL and which is fixed to the lower member 12tL in that state by means of a fastening member 35. The upper member 12tU has a length extending in the vehicle width direction slightly shorter than that of the lower member 12tL. The lower member 12tL has a widened portion 45 formed at both ends thereof in the vehicle width direction, the width of the widened portion 45 gradually increasing in the front-rear direction toward the fixing portion 44 (welded fixing portion) with the frame member 11. Both ends of the upper member 12tU in the vehicle width direction are connected to the narrowest portion of the wide portion 45 of the lower member 12tL by a fastening member 35.

As shown in FIG. 3, the upper member 12tU is provided on its upper surface with a multi-rib structure portion 51 in which the ribs 50 branch into two (a plurality of) ribs from one end side to the other end side in the vehicle width direction (second direction) and then merge into one rib again, and a single rib portion 52 which extends in the vehicle width direction (second direction) and which has an end portion in the extending direction connected to an end portion (single rib 50) in the vehicle width direction of the multi-rib structure portion 51. The multiple rib structure portions 51 and the single rib portions 52 are alternately arranged on the upper surface of the upper member 12tU (third cross member 12t) along the vehicle width direction. A multi-rib structure 51 is provided at each of the both ends of the upper member 12tU (third cross member 12t) in the vehicle width direction. The two of the two-branched ribs 50 of each multi-rib structure 51 extend in the vehicle width direction so as to be parallel to each other. The multiple rib structure portions 51 at the ends on both sides in the vehicle width direction are connected to the widened portion 45 which is closer to the lower member 12tL at a portion where the two ribs 50 join together.

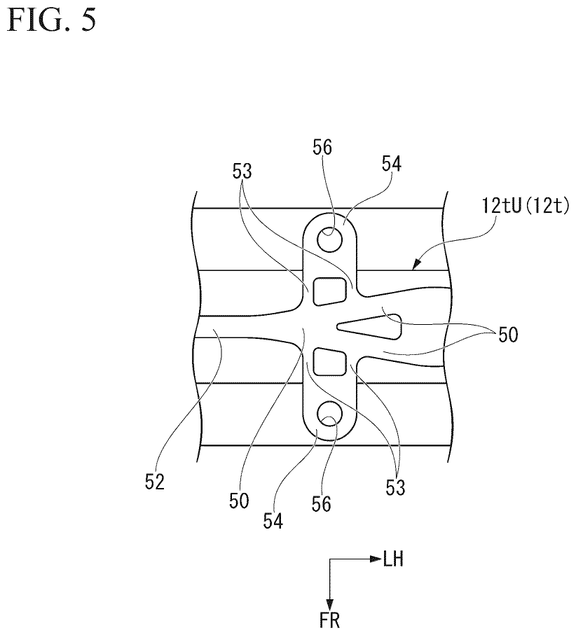

FIG. 5 is an enlarged plan view of a portion of the third cross member 12t corresponding to the V portion in FIG. 3.

A pair of reinforcing ribs 53 extending in parallel to the front side along the front-rear direction and a pair of reinforcing ribs 53 extending in parallel to the rear side along the front-rear direction are integrally formed in the vicinity of a portion where the number of ribs (50) changes from two (a plurality of) to one in each of the multiple rib structure sections (51) of the upper member (12tU). The respective pairs of reinforcing ribs 53 are arranged at a predetermined distance apart from each other in the vehicle width direction. Further, a fastening boss portion 54 to which the edge of the cover wall 42 of the battery module 7 is fastened and fixed is continuously provided at the end portion of each of the reinforcing ribs 53 in the extending direction. Each of the fastening boss portions 54 is formed with an insertion hole 56 into which a shaft portion of the fastening member 55 (see FIG. 3) is inserted.

On the other hand, as shown in FIG. 3, the battery module 7 disposed on the rear side of the third cross member 12t has a cover wall 42 having a front edge portion provided with a fastening tongue 60 which is placed on the upper surface of each fastening boss portion 54 on the rear edge portion of the third cross member 12t. The fastening tongues 60 at the front edge of the cover wall 42 are fastened and fixed to the fastening boss portions 54 by the fastening members 55 in a state where the fastening tongues 60 are placed on the upper surfaces of the corresponding fastening boss portions 54.

Similarly, the battery module 7 disposed on the front side of the third cross member 12t is provided with a fastening tongue 60, being placed on the upper surface of each fastening boss portion 54 of the front edge portion of the third cross member 12t, at a rear edge portion of the cover wall 42 of the battery module 7. Each of the fastening tongues 60 at the rear edge of the cover wall 42 disposed on the front side are placed on the upper surfaces of the corresponding fastening bosses 54, and are fastened and fixed to the fastening bosses 54 by the fastening members 55 in this state.

As shown in FIG. 3, a plurality of fastening bosses 65 are provided on the front edge of the second cross member 12s disposed on the rear side so as to protrude forward. The battery module 7 disposed on the front side of the second cross member 12s is provided with a fastening tongue 67, being placed on the upper surface of each fastening boss portion 65 of the front edge portion of the second cross member 12s, at a rear edge portion of the cover wall 42 of the battery module 7. Each of the fastening tongues 67 at the rear edge of the rear cover wall 42 disposed on the rear side are fastened and fixed to the fastening boss portions 65 by the fastening members 55 in a state where the fastening tongues 67 are placed on the upper surfaces of the corresponding fastening boss portions 65.

Here, the fastening boss portion 54 of the third cross member 12t at the center (connecting portion with respect to the cover wall 42) and the fastening boss portion 65 of the second cross member 12s at the rear side (connecting portion with respect to the cover wall 42) are disposed at positions shifted from each other in the vehicle width direction. That is, the connecting portion of the cover wall 42 at the front edge side with the third cross member 12t and the connecting portion of the cover wall 42 at the rear edge side with the second cross member 12s are all disposed at positions shifted from with each other in the vehicle width direction.

Although FIG. 3 does not show the connecting portion between the first cross member 12f and the front cover wall 42, the connecting portion between the first cross member 12f and the front cover wall 42 has the same structure as the connecting portion between the second cross member 12s and the rear cover wall 42. The connecting portion of the cover wall 42, which is disposed in the front side, to the third cross member 12t disposed on the rear edge side of the cover wall 42 and the connecting portion of the cover wall 42, which is disposed in the front side, to the first cross member 12f disposed on the front edge side of the cover wall 42 are all disposed at positions shifted from with each other in the vehicle width direction.

As described above, in the battery unit 5 of the present embodiment, the front and rear end edges of the cover wall 42 of the battery module 7 are connected to the two adjacent cross members (the third cross member 12t and the second cross member 12s, and the third cross member 12t and the first cross member 12f). Therefore, when an impact load is input to one frame member 11 from one side in the vehicle width direction, the impact load transmitted to the adjacent one cross member is efficiently transmitted to the other cross member through the cover wall 42. As a result, the input impact load is efficiently distributed and supported by the plurality of cross members through the cover wall 42.

In the battery unit 5 of the present embodiment, one of the adjacent cross members (third cross member 12t) is connected to the multiple rib structure portion 51 and the single rib portion 52 in the vehicle width direction, and the edge of the cover wall 42 in the front-rear direction is connected to the vicinity of a portion of the multiple rib structure portion 51 where the number of ribs 50 changes from two to one. Therefore, the impact load transmitted to the multi-rib structure 51 of the third cross member 12t is transmitted to the cover wall 42 through the portion which is relatively easy to vary in the outward opening direction with respect to the input load. As a result, the impact load input to the third cross member 12t is efficiently transmitted to the first cross member 12f and the second cross member 12s through the cover wall 42.

Therefore, when the battery unit 5 of the present embodiment is employed, the input impact load can be efficiently received by the cover wall 42 without increasing the number of cross members or the size of the cross members. Therefore, the input impact load can be efficiently received by the portion other than the battery cell 6 while avoiding the increase in size and weight of the battery housing case 10.

In the battery unit 5 of the present embodiment, the third cross member 12t having the multi-rib structure 51 and the single rib 52 has the widened portion 45 whose front-rear width gradually increases toward the fixing portion 44 with the frame member 11. Therefore, the impact load input to the one frame member 11 from one side in the vehicle width direction is transmitted from the fixing portion 44 of the third cross member 12t with the frame member 11 to the multiple rib structure portion 51 and the single rib portion 52 through the widening portion 45. At this time, since the width of the widening portion 45 is gradually reduced from the fixing portion 44 with the frame member 11 toward the multi-rib structure portion 51 and the single rib portion 52, the load input from the frame member 11 to the third cross member 12t is easily transmitted to the multi-rib structure portion 51 and the single rib portion 52. As a result, the impact load input to the third cross member 12t is easily transmitted to the first cross member 12f and the second cross member 12s through the cover wall 42.

The impact load input from one side of the third cross member 12t is transmitted to the other frame member 11 through the widening portion 45 on the other side of the third cross member 12t. At this time, since the width of the widened portion 45 on the other side gradually increases in the front-rear direction toward the fixing portion 44 with the other frame member 11, the impact load is stably received by the wide range in the front-rear direction of the other frame member 11.

Therefore, when the battery unit 5 of the present embodiment is employed, the input impact load can be received more efficiently by the portion other than the battery cell.

In the battery unit 5 of the present embodiment, a fastening boss portion 54 is provided in the vicinity of a portion of the multi-rib structure portion 51 of the third cross member 12t where the number of ribs 50 changes from two to one, via a pair of reinforcing ribs 53 extending in the front-rear direction. Therefore, the impact load input to the multi-rib structure 51 of the third cross member 12t can be efficiently transmitted to the cover wall 42 through the pair of reinforcing ribs 53.

In the battery unit 5 of the present embodiment, a space S is provided between the frame member 11 and the battery module 7 adjacent thereto, the space S being spaced apart from each other in the vehicle width direction. When an impact load is input to one frame member 11 from one side in the vehicle width direction, the impact load is received by the plurality of cross members and the cover wall 42 of the battery module 7. At this time, even if a part of one frame member 11 is displaced inward in the vehicle width direction, a load is not easily transmitted directly from the frame member 11 to the battery module 7 because a separate space S is secured between the frame member 11 and the battery module 7. Therefore, when the battery unit 5 of the present embodiment is employed, it is possible to protect the battery cell 6 more advantageously at the time of inputting the impact load.

In the battery unit 5 of the present embodiment, two adjacent cross members (the third cross member 12t and the second cross member 12s, and the third cross member 12t and the first cross member 12f) are connected to the edge of the cover wall by the fastening boss portions 54, 65 disposed at positions deviated from each other in the vehicle width direction. Therefore, when an impact load is input to one of the frame members from one side in the vehicle width direction, the load is received by the two adjacent cross members and also by the cover wall 42. At this time, the fastening boss portions 54, 65, which are portions where the load is transmitted from the two cross members to the cover wall 42, are disposed at positions deviated from each other in the vehicle width direction. Therefore, when the battery unit 5 of the present embodiment is employed, the cover wall 42 is less likely to be bent and deformed when an impact load is input, and the impact load can be efficiently received by the cover wall 42.

The present invention is not limited to the above embodiments, and various design changes can be made without departing from the scope thereof. In the above embodiment, three cross members connected to the pair of frame members 11 are provided while being spaced apart in the front-back direction, but the number of cross members is not limited to three. The number of cross members may be four or more, or two or less.

In the above embodiment, the pair of frame members 11 extend in the vehicle body front-rear direction and are disposed so as to be spaced apart from each other in the vehicle width direction, and the first, second and third cross members 12f, 12s and 12t are disposed along the vehicle width direction. However, the arrangement of the frame member and the cross member is not limited to this. For example, the pair of frame members may be disposed so as to extend along the vehicle width direction and to be spaced apart from each other in the vehicle body front-rear direction, and the cross members may be disposed along the vehicle body front-rear direction.

In the above embodiment, the multi-rib structure 51 and the single rib 52 are provided only on one of the adjacent cross members, but the multi-rib structure 51 and the single rib 52 may be provided similarly on both of the adjacent cross members.

Further, although the multi-rib structure 51 of the above embodiment is formed in a shape in which one rib 50 branches into two ribs from one side to the other side in the extending direction and then joins into one rib again, the multi-rib structure 51 may be formed in a shape in which one rib 50 branches into three or more ribs from one side to the other side in the extending direction and then joins into one rib again.

What is claimed is:

1. A battery unit of a vehicle, the battery unit comprising:
a battery module in which battery cells are stored in a module case; and
a battery housing case that is attached to a frame member of a vehicle and that houses the battery module therein;
wherein the battery housing case includes:
a pair of frame members extending along a first direction substantially orthogonal to a vertical direction; and
a plurality of cross members that extend in the vertical direction and a second direction substantially orthogonal to the first direction, and both ends of the cross members in an extending direction being connected to the pair of frame members;
the module case includes a cover wall which covers an upper side of the battery cell, and both ends of the cover wall in the first direction being connected to each of two adjacent cross members,
at least one of the adjacent cross members includes:
a multi-rib structure portion in which a rib is branched from one rib to a plurality of ribs from one end side toward an other end side in the second direction, and then the rib rejoins as one rib; and
a single rib portion extending in the second direction and having an end portion of the single rib portion in an extending direction connected to the multiple rib structure portion, and
the both ends of the cover wall are connected to a vicinity of a portion of the multi-rib structure portion where a number of ribs changes from a plurality of ribs to one rib.

2. The battery unit of a vehicle according to claim 1,
wherein the cross member having the multi-rib structure portion and the single rib portion is provided with a widened portion having a width gradually increasing in the first direction toward a fixing portion with the frame member.

3. The battery unit of a vehicle according to claim 1,
wherein a connecting portion to the cover wall is provided in a vicinity of a portion of the multi-rib structure portion of the cross member where the number of ribs changes from a plurality of ribs to one rib, via a plurality of reinforcing ribs extending in the first direction.

4. The battery unit of a vehicle according to claim 2,
wherein a separate space is provided between the frame member and the battery module to be spaced apart in the second direction.

5. The battery unit of a vehicle according to claim 1,
wherein the two adjacent cross members are provided at positions where connecting portions to the cover wall are shifted from each other in the second direction.
